(19) United States
(12) Patent Application Publication
(10) Pub. No.: US 2006/0287907 A1
(43) Pub. Date: Dec. 21, 2006

(54) Method for providing answer for question on the internet

(76) Inventor: Mi Yeon Kim, Seoul (KR)

Correspondence Address: LADAS & PARRY LLP, 224 SOUTH MICHIGAN AVENUE, SUITE 1600, CHICAGO, IL, 60604, US

(21) Appl. No.: 10/553,479

(22) PCT Filed: May 13, 2004
(86) PCT No.: PCT/KR04/01106

§ 371 Date: Oct. 17, 2005

(30) Foreign Application Priority Data
May 13, 2003 (KR) 10-2003-0030292

(51) Int. Cl. G06F 17/30

(52) U.S. Cl. 705/10

(57) ABSTRACT

The present invention relates to a method for providing answers to a question wherein the quality of the question and answer data posted by users is evaluated to improve the quality of the question and answer in an answer and question service in which the users can ask questions and give answers on the Internet. According to the present invention, there is provided a method for providing answers to a question, which is performed on the Internet, comprising the steps of: receiving a question from a first user, providing the question on a given web page, receiving evaluation data for the question from a second user or an operator of the web page, calculating evaluation result data by reflecting the evaluation data, and providing the evaluation result data on the web page in association with the question.

### TECHNICAL FIELD

The present invention relates to a method for providing answers to a question wherein the quality of the question and answer data posted by users is evaluated to improve the quality of the question and answer in an answer and question service in which the users can ask questions and give answers on the Internet.

### BACKGROUND ART

FIG. 1 shows a network connection of a conventional system for providing answers to a question. Conventionally, one user (a questioner) who wants to ask some questions uses his own user terminal 101 to access a system 100 for providing answers to a question via the Internet 103 and then registers his questions.

Next, another user (an answerer) uses his own user terminal 102 to access the system 100 for providing answers to a question via the Internet 103 and then registers his answers to the questions. Through this configuration, users can ask questions and give answers on the Internet. As such, the questioner can get answers to his questions.

Further, a system 100 for providing answers to a question includes a given database for storing the questions and the answers to the questions and provides a search service to a user who accesses thereto via the Internet 103.

In the prior art, however, if users register insincere questions or answers, or if the users register answers regardless of the questions asked, it is impossible to prevent the level of questions and answers from degrading. Users can be prevented from registering answers or questions containing slang by practicing a passive rule such as prohibiting the users from inputting slang, etc. This method, however, has problems that it cannot prohibit questions or answers from being registered if slang is expressed indirectly and cannot improve the level of questions and answers in a positive manner.

Alternatively, there has been used a method in which a given administrator confirms the contents of a question and an answer and deletes improper questions and answers. This method also cannot improve the level of questions and answers in a positive way. Further, there is a problem in that many more administrators have to invest a great deal of time for verification as the quantity of question data and answer data related to an answer and question service increases.

Therefore, a case where a questioner could not get an answer suitable for his question frequently occurs. Although questions and answers are not directly registered, there is a high possibility that users who access the system 100 for providing answers to a question to search answers and questions are provided with useless information.

Moreover, as the quantity of question data and answer data related to the answer and question service increases, it is important to single out incorrect or inappropriate answer data so as to maintain the answer and question service.

### DISCLOSURE OF INVENTION

The present invention is conceived to solve the aforementioned problems in the prior art. An object of the present invention is to induce users to input questions of a high level spontaneously in such a manner that evaluation data for questions is received from users and evaluation result data for questions are provided to a given web page in association with the questions.

Another object of the present invention is to provide a method for providing answers to a question in which users are induced to input answers of a high level spontaneously, in such a way that if answers to a question are input, votes for the answers are received from the users and a polling score obtained as a result of the voting is provided to the web page in association with the answers. This method for providing answers to questions has its purpose to induce users to input answers and compensate users who provide good answers, by providing predetermined points to a user who has input an answer or a user who inputs an answer having a high polling score.

A further object of the present invention is to provide a method for providing answers to a question in which users are induced to input questions of a high level, in such a manner that if a user who input a question inputs evaluation data for an answer while adopting the answer, predetermined points are provided to the user who input the adopted answer based on the evaluation data.

A further object of the present invention is to provide a method for providing answers to a question in which the level of an adopted answer is improved, in such a way that if a user raises a problem for the adopted answer even after a question and an answer to a question are finished since the answer is adopted, the user who input the adopted answer is allowed to input additional information.

A further object of the present invention is to provide a method for providing answers to a question in which users can easily use questions and answers of a high level in such a manner that if a question and an answer to the question are completed, recommendations for the question and the answer are received from the users and the recommendations are displayed on a web page or the recommended questions and answers are located at the top upon search.

To achieve the foregoing objects and to resolve the problems of the conventional art, there is provided a method for providing answers to a question, which is performed on the Internet, comprising the steps of: receiving a question from a first user, providing the question on a given web page, receiving evaluation data for the question from a second user or an operator of the web page, calculating evaluation result data by reflecting the evaluation data, and providing the evaluation result data on the web page in association with the question.

According to aspect of the present invention, there is provided a method for providing answers to a question, which is performed on the Internet, comprising the steps of: providing a question input by a first user on a given web page, receiving an answer for the question from a second user, providing the answer on the web page in association with the question, if a plurality of answers are input, receiving voting for the answers from a third user for a predetermined voting period, and increasing a polling score corresponding to the answers in response to the input of the votes.

According to aspect of the present invention, there is provided a method for providing an answer for a question, which is performed on the Internet, comprising the steps of: providing a question input by a first user on a given web page, receiving answers to the question from a second user for a predetermined period, providing answers on the web page in association with the question, if the period has elapsed, receiving input for adopting the answer and evaluation data for the adopted answer from the first user, and increasing point data associated with the second user who input the adopted answer based on the evaluation data.

According to aspect of the present invention, there is provided a method for providing answers to a question, which is performed on the Internet, comprising the steps of: providing a question input by a first user on a given web page, receiving answers for the question from a second user for a predetermined period, providing the answers on a web page in association with the question deciding the question and an answer associated with the question as knowledge data, receiving a recommendation for the knowledge data from a third user, and providing the recommendation on the web page in association with the knowledge data.

### BRIEF DESCRIPTION OF THE DRAWINGS

The above and other objects, features and advantages of the present invention will become apparent from the following description of preferred embodiments given in conjunction with the accompanying drawings, in which:

FIG. 1 shows a network connection of a conventional system for providing answers to a question.

FIG. 2 is a flowchart illustrating a method for providing answers to a question according to an embodiment of the present invention.

FIG. 3 shows examples of a question provided on a web page and evaluation result data for a question.

FIGS. 4a to 4c are flowcharts illustrating a method for providing answers to a question according to this embodiment.

FIG. 5 shows examples of questions and answers provided on a web page if an answer is adopted.

FIG. 6(a) shows an answer provided on the web page if the raised problem is input and FIG. 6(b) shows an example of an input window for inputting the raised problem, which is provided to the fourth user.

FIG. 7 shows an example of an additional answer provided on a web page.

FIG. 8 is a flowchart showing the method for providing answers to a question according to this embodiment.

FIG. 9 is a flowchart illustrating the method for providing answers to a question according to this embodiment.

FIG. 10 shows an example of an input window for inputting a recommendation, which is provided to a user.

FIG. 11 is a block diagram showing the construction of a system for providing answers and a question 1100.

FIG. 12 illustrates a typical computer system in accordance with an embodiment of the present invention.

### BEST MODE FOR CARRYING OUT THE INVENTION

Hereinafter, preferred embodiments of the present invention will be described in detail with reference to the accompanying drawings.

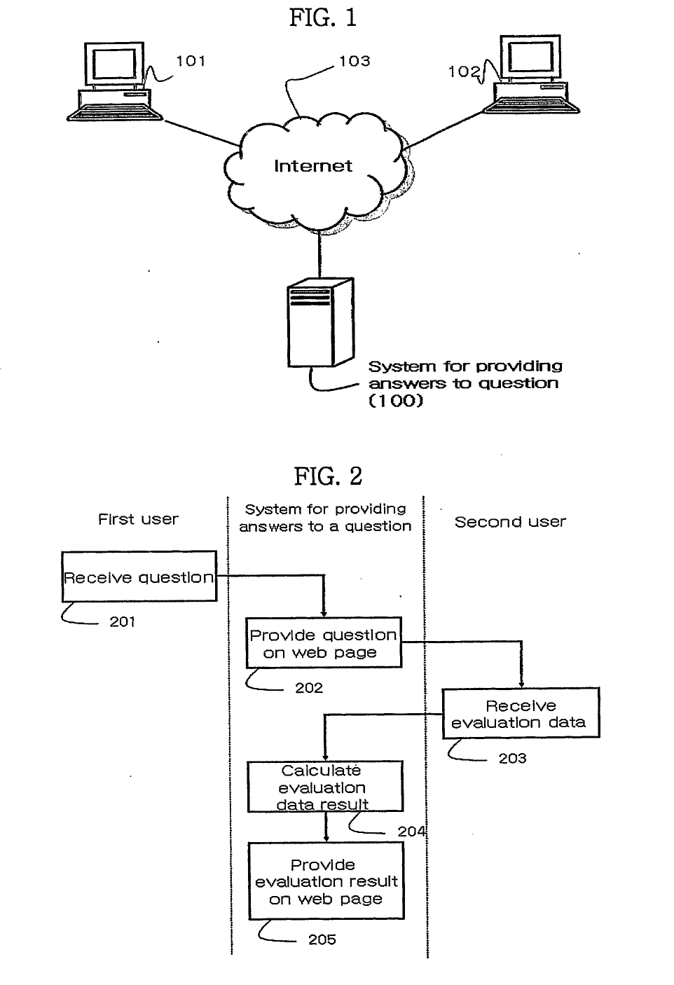

FIG. 2 is a flowchart illustrating a method for providing answers to a question according to an embodiment of the present invention. In order to implement the method for providing answer to a question, a system 100 for providing an answer to a question as shown in FIG. 1 can be used.

The system 100 for providing answers to a question receives a question from a first user (step 201) and provides the question on a given web page (step 202) so that users can view the question.

A second user or an operator of the web page who received the question on the web page inputs evaluation data for the question (step 203). The system 100 for providing answers to a question calculates an evaluation result data by reflecting the evaluation data (step 204).

According to another embodiment of the present invention, the evaluation data is data for selecting “affirmation” or “negation” of the question. The system 100 for providing answers to a question can calculate the evaluation result data in such a manner that if the evaluation data “affirmation” is input, evaluation value data corresponding to the evaluation result data is increased and if the evaluation data “negation” is input, evaluation value data is reduced. For example, if the evaluation data “affirmation” is input, the evaluation value data is increased by 1. If the evaluation data “negation” is input, the evaluation value data is reduced by 1. The evaluation result data is calculated based on the evaluation value data.

Furthermore, according to further another embodiment of the present invention, the system 100 for providing answers to a question assigns a predetermined weight to evaluation data, which is input from a user to which a given authority is assigned by the operator or the operator, to calculate the evaluation result data (step 204). For instance, the system 100 for providing answers to a question increases the evaluation value data by 3 if the evaluation data “affirmation” is input from the user or the operator, and reduces the evaluation value data by 3 if the evaluation data “negation” is input therefrom.

The user to which a given authority is assigned by the operator may be, for example, a user who inputs a plurality of questions and answers and gets a good credit from other users regarding the questions and answers, a user who is recognized as a specialist in a given field according to a given method and so on. If a user recognized as a specialist inputs evaluation data for a question corresponding to his field, a weight is assigned to the evaluation data to calculate evaluation result data. The evaluation of a user or an operator verified as such is recognized in its specialty and reliability by some degree other than common evaluation. It is thus possible to obtain a more exact evaluation by assigning a predetermined weight to the evaluation of a verified user or operator.

The system 100 for providing answers to a question provides the evaluation result data on the web page in association with the question (step 205). The evaluation result data can be expressed as a predetermined graph so that it can be easily viewed by users.

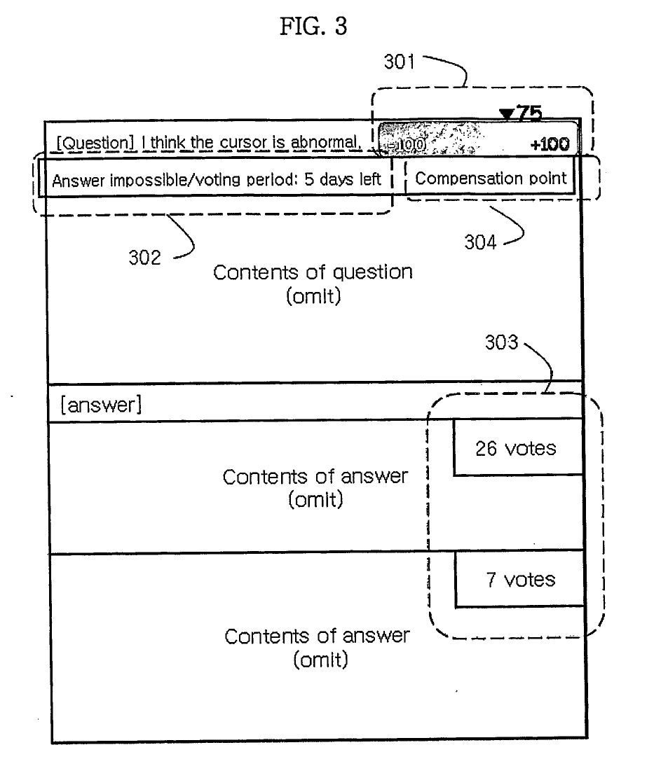

FIG. 3 shows examples of a question provided on a web page and evaluation result data for a question. Reference numeral 301 indicates evaluation result data provided using a graph of a gauge form. FIG. 3 shows evaluation result data wherein the gauge is relatively calculated from −100 to +100. Therefore, a user can easily recognize evaluation of other users for a question through only the position of a “▾” in the graph. Description on reference numerals 302, 303 and 304 in FIG. 3 will be given later.

Furthermore, although not shown in FIG. 2, the system 100 for providing answers to a question according to a further embodiment of the present invention may further perform the step of displaying the question according to a predetermined display method if the evaluation result data is not coincident with a predetermined reference. For instance, if the evaluation result data is not coincident with the predetermined reference, a method of displaying a question on a web page with a lower resolution compared to other questions, a method of additionally displaying a given icon in association with the question and the like can be used.

Alternatively, although not shown in FIG. 2, the system for providing an answer for a question 100 according to a still further embodiment of the present invention can compensate the first user by increasing the point data associated with the first user by a predetermined value if an evaluation result data exceeds a predetermined reference.

Through the above configuration, in the method for providing answers to a question according to this embodiment, a user who inputs a question is induced to input a good question in order to receive good evaluation from other users or get predetermined points.

In addition, according to another embodiment of the present invention, the system 100 for providing answers to a question can induce users to actively participate in the evaluation of a question by increasing the point data associated with a second user who input evaluation data by a predetermined value.

As such, the method for providing answers to a question according to the present invention includes providing a predetermined point to a user who actively participates in the answer and question service by inputting evaluation data. However, the method for increasing evaluation data by a predetermined value whenever evaluation data is input can be misused by a user as a means for simply increasing his points without sincerely participating in the answer and question service such as a “click” for inputting evaluation data “without confirming” the contents of a question or with no regard to the level of the question.

Accordingly, the method for providing answers to a question according to a still further embodiment of the present invention may further include the steps of receiving a limit number corresponding to a predetermined unit period from an operator, counting the number that the second user inputs an evaluation data for the unit period, and only if the input number is below the limit number, increasing the point data associated with the second user by the predetermined value in response to the input of the evaluation data.

The unit period may be “12 hours” or “1 day” and can be set by an operator. Through this configuration, it is possible to prevent a bad user described above from rapidly increasing their points and to prevent points associated with a user from increasing sharply.

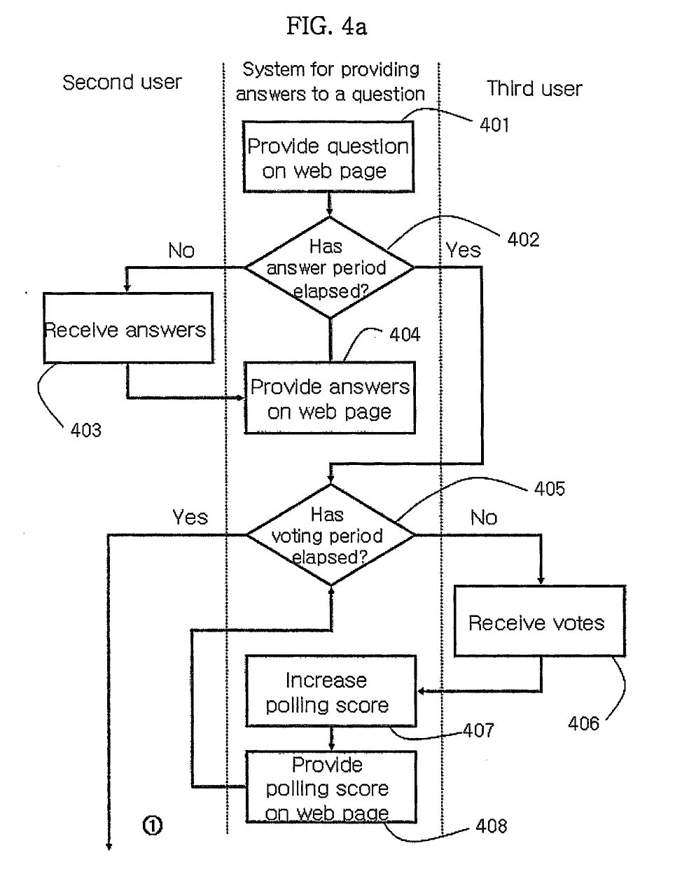

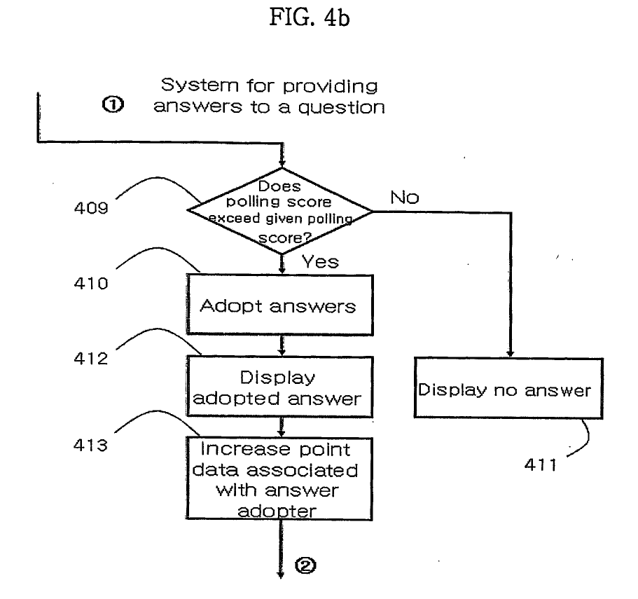

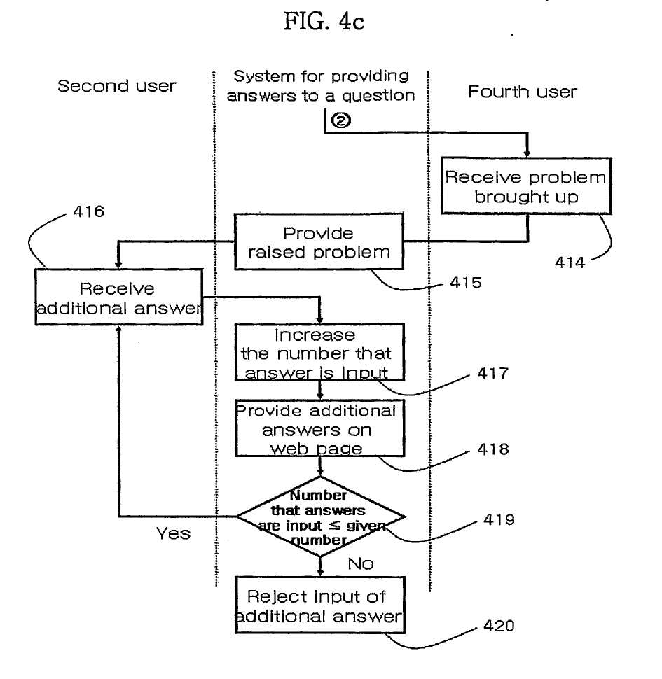

The method for providing answers to a question according to a still further embodiment of the present invention will be hereinafter described. FIGS. 4a to 4c are flowcharts illustrating a method for providing answers to a question according to this embodiment.

The system 100 for providing answers to a question provides a question input by a first user on a given web page (step 401) so that users can read the question and receive answers to a question from a second user for a predetermined period (step 403).

According to another embodiment of the present invention, the system 100 for providing answers to a question can receive an answer from a second user only for a predetermined answer period. The system 100 determines whether the answer period has elapsed (step 402). In step 403, the system 100 receives an answer from a second user only when the answer period has not elapsed. As the answer is received only for the answer period, the first user does not need to wait an unlimited time for an answer. Further, as votes for answers are input only when the answer period has elapsed in step 402, objectivity of voting as described above can be secured.

The answer period may be a predetermined period that is input by a first user, or a period that is collectively set for a question by the system 100 for providing answers to a question. Accordingly, if a first user inputs a proper period for the question as the answer period, the system 100 for providing answers to a question allows an answer to be input only for the input answer period.

The system 100 for providing answers to a question provides answers on a web page in association with the question, as describe above (step 404).

The system 100 for providing answers to a question determines whether a predetermined voting period has elapsed (step 405). If it is determined that the predetermined voting period has not elapsed, the system 100 receives votes for answers from a third user (step 406).

The voting period can be displayed on the web page as indicated by reference numeral 302 in FIG. 3. Users can participate in the vote referring to the voting period indicated on the web page.

According to another embodiment of the present invention, the system 100 for providing answers to a question receives a vote from a third user only when there are a plurality of answers. This is because if there is only one input answer, it is not meaningful to vote in order to adopt an answer. According to another embodiment of the present invention, even if one answer is input, a vote for the one answer is received from a third user with respect to “answer affirmed” or “answer negated”. A questioner or the system 100 for providing answers to a question can use the voting results to select “adopt as an answer” or “no answer” for the one response.

Although not shown in FIG. 4, the system 100 for providing answers to a question according to a still further embodiment of the present invention may further include the step of increasing the point data associated with a third user by a predetermined value corresponding to the vote input. As such, by providing a predetermined point to a user who participates in a vote, users are induced to actively participate in voting.

Furthermore, as described in the aforementioned embodiment, in order to prevent a condition wherein users input votes regardless of the contents or level of an answer as a means for increasing their points or a phenomenon where points associated with users increase rapidly (in this case, the value of points is reduced), the method for providing answers to a question according to a still further embodiment of the present invention may further include the steps of receiving a limit number corresponding to a predetermined unit period from an operator, counting the number of times that a third user inputs a vote during the unit period, and only when the input number is below the limit number, increasing point data associated with the third user by the predetermined value in response to the vote input.

Meanwhile, in order to prevent repetitive voting for the same answer with the intention of getting more points, the system 100 for providing answers to a question according to a still further embodiment of the present invention perceives information on a user who inputs a vote, and then does not allow the same user to input a vote for the same answer again or does not reflect the vote in the polling score (to be described later) or the assignment of points.

As described above, the system 100 for providing answers to a question receives votes from a third user only when the answer period has elapsed. As such, by setting a time point where a vote begins to a time point where the predetermined answer period elapses, advice that is input first gets more polling scores than advice that is input later. It is thus possible to prevent the common opinion of users from not being reflected properly.

Moreover, the system 100 for providing answers to a question receives votes for answers only during the voting period. According to an embodiment of the present invention, the voting period may be a predetermined period input by the first user. Also, according to another embodiment of the present invention, the voting period may be a period where the number of voters input by the first user is reached. For example, the first user can input 100 as the number of voters, and the system 100 for providing answers to a question can be set so that the vote for answers is closed when the total number of voters reaches 100.

In a case where the number of voters for an answer is set to 100, however, if the number of voters for an answer does not reach 100 for a very long time, there may be a problem that voting is not finished but the question and answers to the question are left for a long time. In order to solve the above problem, a method for providing an answer to a question according to further another embodiment of the present invention can receive a voting period and a total number of voters from a first user at the same time, and finish voting if the voting period or the number of voters is met. For instance, if a first user sets the voting period to 10 days from a time point where voting begins and the number of voters to 100, the system 100 for providing answers to a question finishes voting if the voting period of 10 days elapses or the total number of voters reaches 100.

Alternatively, according to another embodiment of the present invention, the voting period may be a given period set by an operator who manages an answer and question service or a period where the given number of voters set by the operator is reached. That is, the system 100 for providing answers to a question can allow a user to set the voting period or allow an operator to set the voting period.

The system 100 for providing answers to a question increases a polling score corresponding to the answer in response to the input of votes (step 407) and provides a polling score on the web page in association with the answers, as indicated by reference numeral 303 in FIG. 3 (step 408).

The system 100 for providing answers to a question according to a still further embodiment of the present invention may further perform the steps of determining whether a third user is coincident with the first user and whether a third user is coincident with the second user, before performing step 407. If it is determined that the third user is coincident with the first or second user, the system 100 for providing answers to a question does not increase the polling score for the answer even if the vote is input. Through this configuration, a user who inputs a question or an answer is not allowed to participate in voting. It is thus possible to obtain an objective evaluation for a given answer.

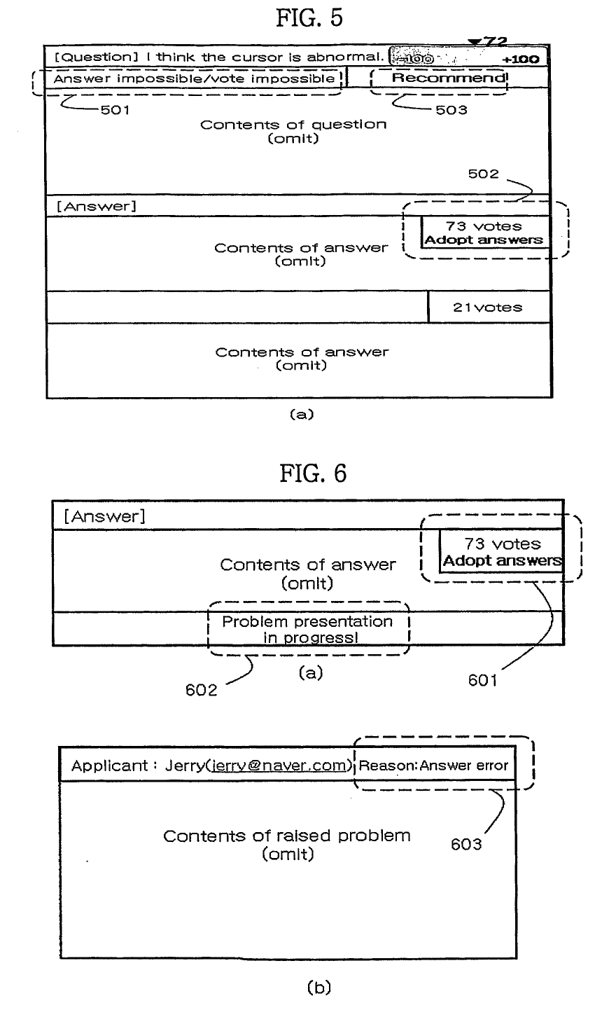

If it is determined that the voting period has elapsed in step 405, the system for providing the answer for the question 100 adopts one or more answers based on the polling score (step 410). FIG. 5 shows examples of questions and answers provided on a web page if an answer is adopted. After the voting period elapsed, the input of votes is no longer allowed, as indicated by reference numeral 501 in FIG. 5.

According to an embodiment, the system 100 for providing answers to a question may adopt one answer having the greatest polling score, a given number of answers in descending order of polling scores or all answers having a predetermined polling score.

Furthermore, according to another embodiment of the present invention, the system 100 for providing answers to a question determines whether a polling score for an input answer exceeds a predetermined polling score (step 409). If there is no answer reaching the predetermined polling score, the system 100 does not adopt any answer. Through this configuration, although an answer has the greatest polling score, if the answer does not have the predetermined polling score, it is not adopted as an answer. Thus, an answer that does not meet a given reference is prevented from being adopted. For example, if three answers for a question are input and polling scores corresponding to the respective answers are 3 votes, 2 votes and 5 votes, the answer having only 5 votes is prevented from being adopted (although it depends on the total number of users using the answer and question service).

If there is no answer having a predetermined polling score, the system 100 for providing answers to a question indicates that there is no adopted answer in relation to the question (step 411). Users can use the polling score corresponding to each answer, the fact that it is an adopted answer, the fact that there is no adopted answer, etc. as a reference for determining the contents of each answer.

The system 100 for providing answers to a question indicates the adopted answer according to a predetermined display method (step 412). As indicated by reference numeral 502 in FIG. 5, a method for simply displaying an adopted answer, a method for locating an adopted answer at the top of a list of answers regardless of time when the answer was input, a method for indicating an adopted answer with a different shape or color from other answers and so on can be used.

The system 100 for providing answers to a question decides a second user who input an adopted answer as an answer adopter and increases the point data associated with the answer adopter by a predetermined value (step 413). Users are induced to input answers of a high level by compensating a user who inputs an adopted answer as points.

According to another embodiment of the present invention, step 413 includes the steps of maintaining point data associated with a user in a point database, receiving compensation point data from a first user, increasing the point data associated with the answer adopter by the compensation point data based on the compensation point data, and reducing the point data associated with the first user by the compensation point data.

The compensation points are a portion of the points held by the first user and are points that are paid to an answer adopter who input an answer adopted by the first user. Compensation points are different from common points in that a user rather than an operator of an answer and question service provides the compensation points to other users.

In FIG. 3, reference numeral 304 indicates compensation point data. That is, the first user puts 20 as the compensation point. If an answer is adopted, compensation point data associated with an answer adopter increases by 20. Moreover, the compensation points are provided by the first user. Thus, if the compensation point data associated with the answer adopter increases by 20, point data associated with the first user reduces by 20. The point data as described above is maintained in the compensation point database in association with a user.

According to this embodiment, the first user himself can determine the value of the compensation point data. Therefore, the first user can easily accomplish the desired object by inputting a high compensation point data regarding an important question or a question for which an answer must be urgently obtained. Also, the first user can input 0 (i.e., no compensation point) as the value of the compensation points.

Furthermore, according to another embodiment of the present invention, the step of increasing the point data associated with the answer adopter by the compensation point data based on the compensation point data includes the steps of, if answers are adopted in plural, distributing the compensation points input by the first user in the ratio of polling scores corresponding to the respective answers, and increasing the point data associated with the answer adopters by the distributed compensation point data.

As described above, the system 100 for providing answers to a question may adopt one or more answers. If a plurality of answers are adopted, compensation points must be provided to respective answer adopters. It is thus necessary to distribute the compensation points by answer adopter. At this time, although a method for equally distributing the compensation points to the answer adopters can be used, it is preferred that the compensation points be distributed to the answer adopters by reflecting polling scores corresponding to the adopted answers.

Therefore, the system 100 for providing answers to a question distributes the compensation points in the ratio of the polling scores and provides the distributed compensation points to the answer adopters. For instance, if the compensation points equal 100, the number of adopted answers is 4, and polling scores corresponding to the respective answers are 70, 55, 50 and 25, points associated with the answer adopters that input the respective answers increase would be 35 points, 27 points, 25 points and 12 points (in descending order). At this time, points associated with the first user reduce by 100, as explained above.

Meanwhile, the system 100 for providing answers to a question does not adopt an answer based on polling score but can allow the first user who input the question to elect one of answers input, as described above. At this time, the method for adopting an answer through voting can be used supplementally (or together) only when the first user himself cannot adopt an answer.

At this time, the system 100 for providing answers to a question can receive votes for the answer only when a vote return command for the answer is received from the first user. Therefore, the first user can adopt an answer himself or according to vote results.

Moreover, according to another embodiment of the present invention, the system for providing answers to a question allows a user to input additional answers corresponding to a problem brought up from users if there is error in the contents of an answer although the answer is adopted through the above steps 401 to 410.

The system 100 for providing answers to a question receives a question raised for the adopted answer from a fourth user (step 414) and provides the raised problem to the second user who input the adopted answer (step 415).

A user who received the raised problem can give additional answers to the problem (step 416). The system 100 for providing answers to a question provides the additional answers on the web page in association with the adopted answer.

Furthermore, the system 100 for providing answers to a question provides additional answers for the raised problem to the user and also notifies the first user who input the question of the fact that an additional answer will be provided via e-mail or SMS, so that the first user can receive a modified or supplemented answer.

FIG. 6(a) shows an answer provided on the web page if the raised problem is input and FIG. 6(b) shows an example of an input window for inputting the raised problem, which is provided to the fourth user.

In FIG. 6(a), reference numeral 601 indicates that an answer provided on the web page is an adopted answer. Reference numeral 602 designates the fact that a problem brought up for the adopted answer has been input. As such, by indicating that an answer is one for which a problem is brought up although it is an adopted answer, users who receive the answer can consider this fact when determining reliability, etc. of the answer.

Meanwhile, only the fact that the problem brought up is input is shown in FIG. 6 (a). In the system 100 for providing answers to a question, however, the contents of the raised problem can be provided through a “pop-up” window so that it is shown when clicking on reference numeral 602. That is, the raised problem is provided in association with the adopted answer.

In FIG. 6(b), as indicated by reference numeral 603, a fourth user can further input a category to which a reason why the problem is brought up belongs as well as the contents of the problem. The category may include “erroneous answer”, “additional contents of an answer needed”, “typographic error” and so on, as shown. The raised problem can be provided to the second user by displaying the contents of the raised problem on a web page or transmitting the raised problem to the second user via e-mail, mobile communication terminal, etc.

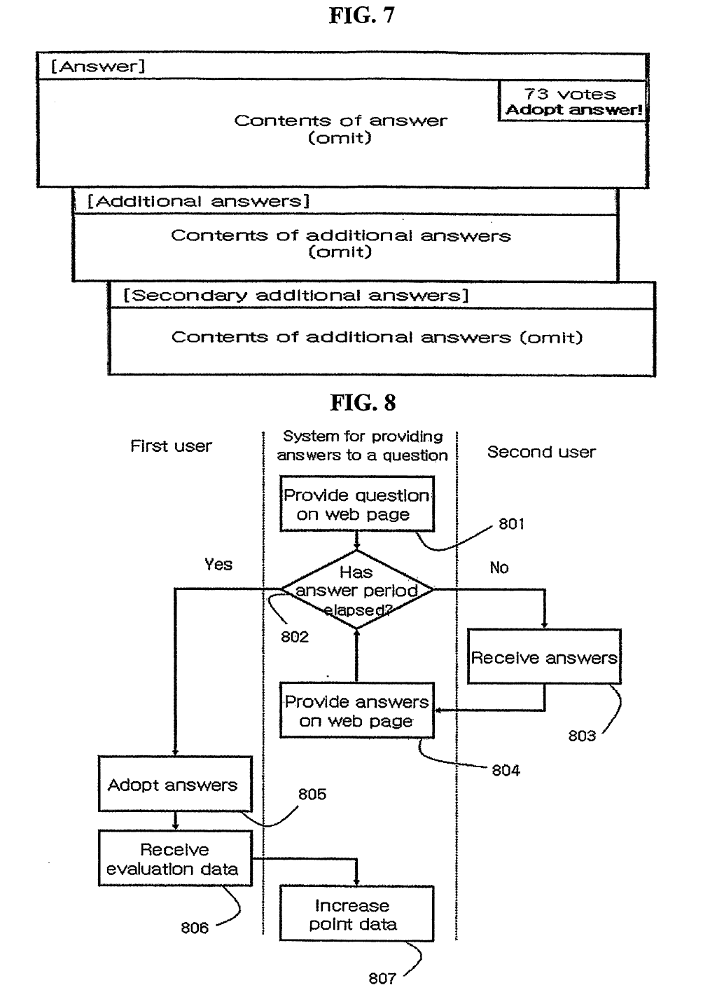

FIG. 7 shows an example of an additional answer provided on a web page. As shown in FIG. 7, the additional answer can be given by a method such that an additional answer is attached without modifing the contents of the “adopted answer” and keeping the adopted answer intact. If this attachment method is used, even other users other than the second and fourth users can confirm portions modified according to the problem presentation and can understand the history related to the answer.

Moreover, according to another embodiment of the present invention, the system 100 for providing answers to a question counts the number of additional answers received from the second user (step 419) and rejects further input of additional answers if the number exceeds a predetermined number (step 420).

There is a case that although the user gave an additional answer with respect to a problem raised with the adopted answer, the user finds the additional answer to be insufficient and thus wants to input additional answer again, Further, if a plurality of problems are raised for the adopted answer, the second user can give one additional answer for each raised problem. If the plural raised problems are input with some time distance, the second user must input the additional answers in plural.

To receive plural additional answers for a question for which answers are input and adopted and then provide them on a web page can make users inconvenient in using the answer and question service since they have to read the additional answers added to the adopted answer as well as the “adopted answer”.

Accordingly, as described above, it is necessary to count the number of additional answers input and thus limit the number of the additional answers. This configuration has an advantage that users are induced to input answers of high completeness from the beginning by limiting the number of additional answer input to a predetermined number.

Meanwhile, there is a case that the second user who received a raised problem does not agree with the problem presentation. At this time, the system 100 for providing answers to a question can further perform the steps of receiving the cause of a rejection why the second user does not agree with the problem presentation from the second user and providing the cause of the rejection to the fourth user.

Furthermore, if the second user who received the raised problem does not respond to the problem presentation, problems that the fourth user feels are inconvenient since the user does not receive a response and the other users do not believe in the adopted answer since they do not know the result of the problem presentation.

Therefore, the system 100 for providing answers to a question according to another embodiment of the present invention increases the points associated with a user who inputs an additional answer or the cause of a rejection for the problem presentation by a predetermined value, and decreases points associated with a user who does not respond to the problem presentation for a predetermined period by a predetermined value, so that the second user is induced to respond sincerely.

In addition, the system 100 for providing answers to a question can increase only point data associated with a user who inputs an additional answer or the cause of a rejection for the problem presentation by a predetermined value. If the second user does not access the web page for a predetermined period or read a received e-mail, there is a danger that a predetermined point data associated with the second user may be reduced while the second user does not know about it.

A method for providing an answer for a question according to further another embodiment of the present invention will be hereinafter described. FIG. 8 is a flowchart showing the method for providing answers to a question according to this embodiment.

A system 100 for providing answers to a question provides a question input by a first user on a given web page (step 801) and determines whether a predetermined answer period has elapsed (step 802). If it is determined that the predetermined answer period has not elapsed, the system 100 for providing answers to a question receives answers to the question from a second user (step 803) and provides the answers to a web page in association with the question (step 804). The answer period has been described in detail in the aforementioned embodiment. Thus, description thereon will be omitted in this embodiment.

If the answer period has elapsed in step 802, the system 100 for providing answers to a question receives an input for adopting an answer and evaluation data for the adopted answer from the first user (step 805 and 806).

The evaluation data may be any one of a given number of evaluation grades. That is, the system 100 for providing answers to a question presents a plurality of evaluation grades to the first user and the first user can input one of the plurality of the evaluation grades as the evaluation data. The evaluation grade may be either “affirmation” or “negation”, as described above, and may be classified into 3 or more grades. Such evaluation grades may include, for example, grades using icons such as “⋆”, “⋆⋆”, “⋆⋆⋆⋆⋆”.

The system 100 for providing answers to a question increases point data associated with the second user who input the adopted answer based on the evaluation grade (step 807). At this time, the system 100 for providing answers to a question may use a method for maintaining a point data value corresponding to the evaluation grade in a predetermined database and increasing the point data associated with the second user by the point data value corresponding to the evaluation grade.

For instance, if a point data value corresponding to 1 point for every “⋆” is maintained as an evaluation data, the system 100 for providing answers to a question increases the point data associated with the second user by 1 point if “⋆” is input as the evaluation data from the first user, and increases the point data by 5 points if “⋆⋆⋆⋆⋆” is input as the evaluation data from the first user.

According to this configuration, although an answer is an adopted answer, a given grade is assigned to the adopted answer. More compensation is given to a user who inputs an answer of a higher level. Users are thus are induced to input answers of a high level.

Furthermore, the system 100 for providing answers to a question according to a further embodiment of the present invention allows the first user to adopt a plurality of answers among input answers, like the method for providing the answer for a question wherein answers are adopted according to vote. At this time, the method for providing answers to a question according to this embodiment may further includes the steps of receiving predetermined compensation point data and evaluation data for each of a plurality of adopted answers from the first user, distributing the compensation point data in the ratio of the evaluation data corresponding to each of the answers, and increasing the point data associated with each of second users who input the adopted answers by the distributed compensation point data. If the point data of the second users increase, the point data associated with the first user is reduced in and equal amount.

Therefore, if the first user who input a question adopts a plurality of answers, the point data of the first user can be distributed to users who input the adopted answers.

Meanwhile, the system 100 for providing answers to a question according to this embodiment can further perform the aforementioned steps of receiving problems brought up with an adopted answer and providing additional answers.

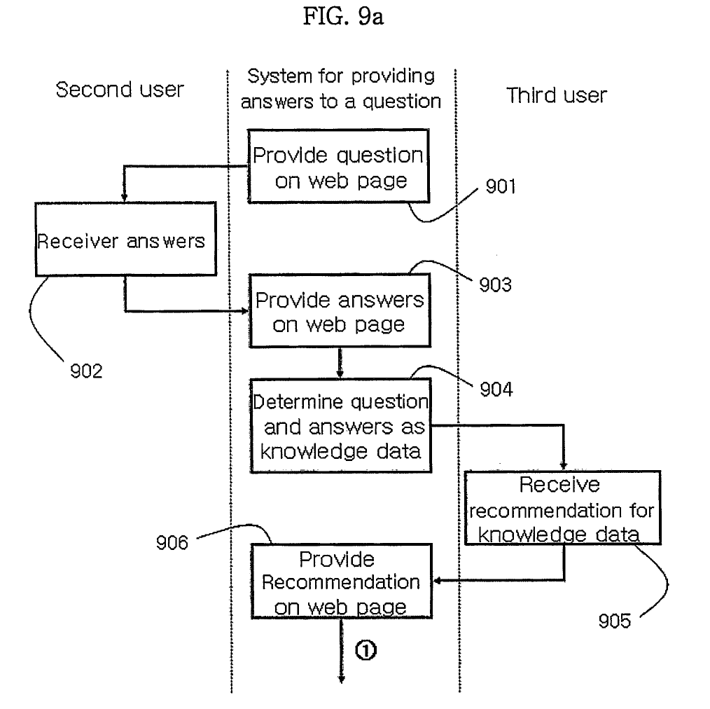

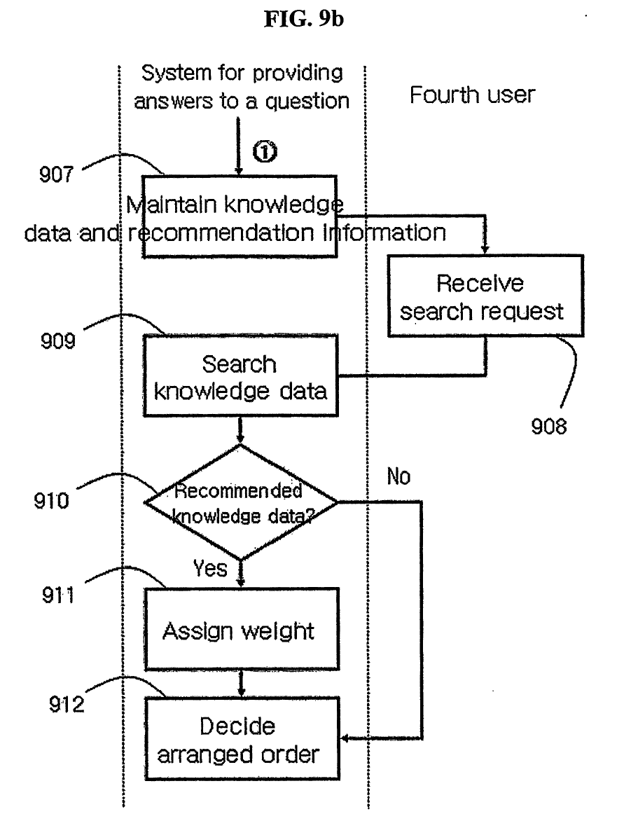

A method for providing answers to a question according to another embodiment of the present invention will now be described with reference to FIG. 9. FIG. 9 is a flowchart illustrating the method for providing answers to a question according to this embodiment. A system for providing answers and a question 100 provides a question input by a first user to a given web page (step 901), receives answers to the question from a second user for a predetermined period (step 902) and provides the answers to the web page in association with the question (step 903).

The system 100 for providing answers to a question decides the question and answer associated with the question as knowledge data (step 904). According to another embodiment of the present invention, step 904 is performed when the input of answers and the adoption of answers are completed. Accordingly, with no filimer changes in the question and answers, the question and the answers are decided as knowledge data.

The system 100 for providing answers to a question receives a recommendation for knowledge data from a third user (step 905). According to another embodiment of the present invention, the system 100 for providing answers to a question determines whether a third user is coincident with the first user who input the question and a second user who input the adopted answer. If it is determined that the third user is not coincident with the first or second user, the system 100 receives a recommendation. It is thus possible to maintain objectivity of recommendations. The third user can input a recommendation for knowledge data by clicking on a “recommendation” button as shown in FIG. 5.

The system 100 for providing answers to a question provides the recommendation on the web page in association with the knowledge data (step 906). According to another embodiment of the present invention, the knowledge data containing the recommendation is displayed according to a predetermined display method so that it can be discriminated from the other knowledge data. Knowledge data containing the recommendation can be displayed by a method for displaying the letters, background color, size of the letters, etc. in different manner or a method for additionally further displaying relevant icons. Therefore, a user can easily read the knowledge data containing the recommendation.

Moreover, according to another embodiment of the present invention, step 905 includes the step of receiving a category associated with the knowledge data from a third user, and step 906 includes the step of displaying the category in association with the knowledge data. Accordingly, users who want to receive knowledge associated with a category can easily read knowledge data, which is associated with the category and recommendation, using the category displayed on the web page.

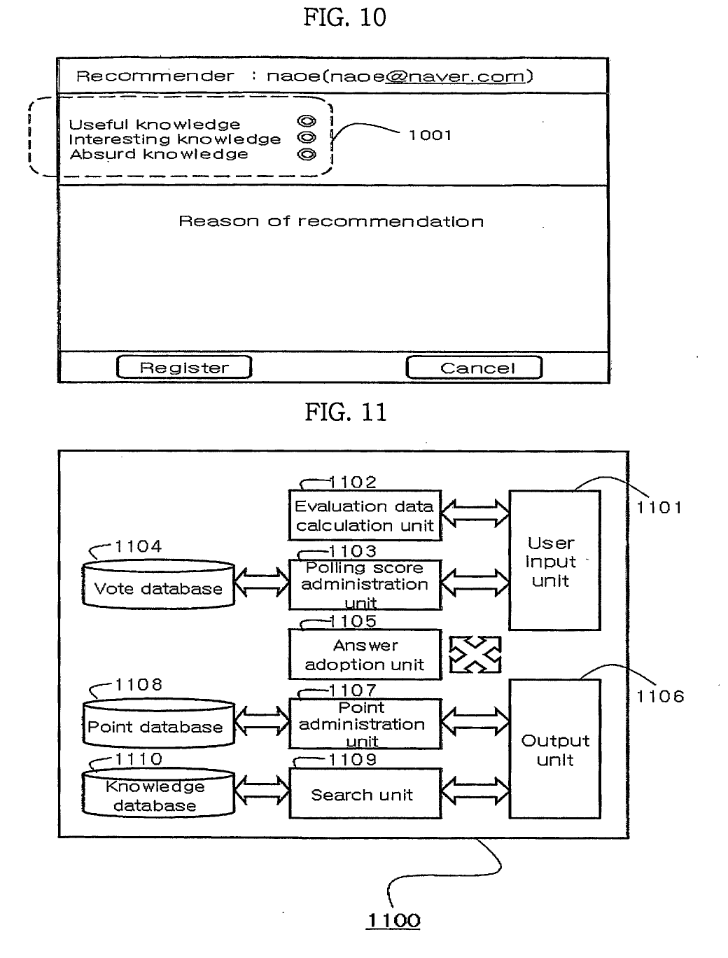

FIG. 10 shows an example of an input window for inputting a recommendation, which is provided to a user. As indication by reference numeral 1001, users can select one of the categories (categories may include “useful knowledge”, “interesting knowledge” and “absurd knowledge”, as shown in FIG. 10) that are provided by the system 100 for providing answers to a question and then input a recommendation. According to an embodiment, a fourth user may directly input a category.

The system 100 for providing answers to a question maintains knowledge data and recommendation information associated with the knowledge data in a knowledge database (step 907). Recommendation information is information indicating whether a recommendation for the knowledge data has been input.

If a search request for knowledge data is received from a fourth user (step 908), the system 100 for providing answers to a question searches the knowledge database for the knowledge data in response to the search request (step 909). At this time, if a plurality of knowledge data are searched as a result of the search, the system 100 determines whether the searched knowledge data are recommended knowledge data based on the recommendation information (step 910), assigns a predetermined weight to the recommended knowledge data (step 911) and determines an order wherein the knowledge data are arranged (step 912). Therefore, whether a recommendation is made can become another factor to decide the arranged order in addition to the coincidence of knowledge data for a searched keyword.

Through the above configuration, users can easily read recommended knowledge data among search results, Further, a service company that provides an answer and question service can preferentially provide recommended knowledge data of a high quality. It is thus possible to improve the answer and question service as a whole.

Furthermore, the present invention provides a computer-readable recording medium in which a program for implementing a method for providing answers to a question according to each of the aforementioned embodiments is recorded.

Meanwhile, the points described in each of the aforementioned embodiments may be real money, cyber money that can be exchanged on the Internet, or mileage. Also, the points may be symbolic such that they cannot be exchanged as a means for improving the honor of a user by informing the fact that the user has actively participated in an answer and question service to provide questions or answers of high quality.

A system for providing an answer and a question service capable of performing the method for providing answers to a question according to the respective aforementioned embodiments will now be described. FIG. 11 is a block diagram showing the construction of a system for providing answers and a question 1100.

A user input unit 1101 receives a question, answers to the question, evaluation data for the question or answer, an answer period, a voting period, compensation point data, problem presentation, additional answers or rejections for the problem presentation from a user, etc.

An evaluation data calculation unit 1102 calculates an evaluation result data for a question based on the evaluation data for the question.

A polling score administration unit 1103 increases the polling scores corresponding to the answers in response to votes input from the user input unit 1101. A vote database 1104 stores the answers, the polling scores corresponding to the answers, and information on the users who provided the answers therein.

An answer adoption unit 1105 receives input for adopting answers from a user who input a question, adopts the answers, or adopts an answer having the highest polling score based on the vote results.

A point administration unit 1107 administrates point data associated with users such as increasing the point data associated with a user who inputs answers or votes if an answer is adopted or the vote is input, and reducing the point data associated with a user who inputs a question by the compensation point data if the user who inputs the question inputs compensation point data and an answer for the question is adopted. A point database 1 108 maintains point data associated with each user therein.

A search unit 1109 searches knowledge data stored in the knowledge database 1110 in response to a search request from a user.

An output unit 1106 provides the question, answers to the question, evaluation result data for the question, polling scores corresponding to the answers, search results, etc. on a web page so that users can read them.

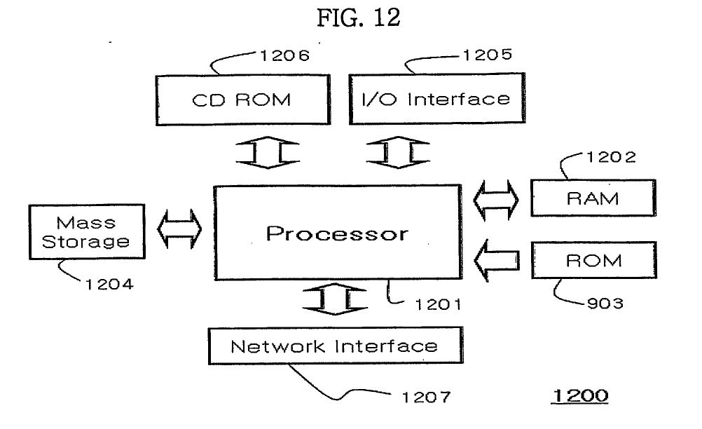

FIG. 12 illustrates a typical computer system in accordance with an embodiment of the present invention.

The computer system 1200 includes any number of processors 1201 (also referred to as central processing units, or CPUs) that are coupled to storage devices including primary storage 1202 (typically a random access memory, or “RAM”), primary storage 1203 (typically a read only memory, or “ROM”). As is well known in the art, primary storage 1202 acts to transfer data and instructions uni-directionally to the CPU and primary storage 1202 is used typically to transfer data and instructions in a bi-directional manner. Both of these primary storage devices may include any suitable type of the computer-readable media described above. A mass storage device 1204 is also coupled bi-directionally to CPU 1201 and provides additional data storage capacity and may include any of the computer-readable media described above. The mass storage device 1204 may be used to store programs, data and the like and is typically a secondary storage medium such as a hard disk that is slower than primary storage. A specific mass storage device such as a CD-ROM 1206 may also pass data uni-directionally to the CPU. Processor 1201 is also coupled to an interface 1205 that includes one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, processor 1201 optionally may be coupled to a computer or telecommunications network using a network connection as shown generally at 1207 With such a network connection, it is contemplated that the CPU might receive information from the network, or might output information to the network in the course of performing the above-described method steps. The above-described devices and materials will be familiar to those of skill in the computer hardware and software arts.

The hardware elements described above may be configured (usually temporarily) to act as one or more software modules for performing the operations of this invention.

### INDUSTRIAL APPLICABILITY

According to the present invention as described above, there is provided a method for providing answers to a question wherein evaluation data for a question are received from users and are then provided on a given web page, so that users are induced to input good questions.

Furthermore, according to the present invention, there is provided a method for providing answers to a question wherein votes are received from users regarding an answer for a question and the vote results are provided on a web page, so that users are induced to input good answers.

Also, according to the present invention, there is provided a method for providing answers to a question wherein if a user raises a problem for an adopted answer, the user who input the adopted answer is allowed to input an additional answer, whereby the level of an adopted answer is increased.

In addition, according to the present invention, there is provided a method for providing answers to a question wherein a question and an answer are decided as knowledge data and a recommendation for the knowledge data is received, so that knowledge data of a high level is easily provided to users.

Incidentally, according to the present invention, there is provided a method for providing answers to a question wherein a user who actively participates in an answer and question service and a user who inputs a question or answer of a high level are compensated through points, so that users are induced to spontaneously participate in the answer and question service.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A method for providing answers to a question, which is performed on the Internet, comprising the steps of:
(a) receiving a question from a first user;
(b) providing the question on a given web page;
(c) receiving evaluation data for the question from a second user or an operator of the web page;
(d) calculating evaluation result data by reflecting the evaluation data; and
(e) providing the evaluation result data on the web page in association with the question.

2. The method as claimed in claim 1, wherein step (e) comprises the step of displaying the evaluation result data as a predetermined graph.

3. The method as claimed in claim 1, further comprising the step of displaying the question according to a predetermined display method if the evaluation result data is not coincident with a predetermined reference.

4. The method as claimed in claim 1, wherein:
step (c) comprises the step of receiving one of “affirmation” and “negation” for the question from the second user or the operator, and step (d) comprises the steps of:
increasing given evaluation value data corresponding to the evaluation result data if the “affirmation” is received; and
reducing the evaluation value data if the “negation” is received.

5. The method as claimed in claim 1, wherein step (d) comprises the steps of:
determining whether the received evaluation data is evaluation data that is received from the operator or a user to which predetermined authority has been assigned by the operator; and
calculating the evaluation result data by assigning a predetermined weight to the evaluation data that is received from the operator or the user to which predetermined authority has been assigned by the operator.

6. The method as claimed in claim 1, further comprising the step of increasing point data associated with the second user by a predetermined value in response to the input of the evaluation data.

7. The method as claimed in claim 6, wherein the step of increasing the point data by the predetermined value comprises the steps of:
receiving a limit number corresponding to a predetermined unit period from the operator;
counting an input number that the second user inputs the evaluation data during the unit period; and
if the input number is below the limit number, increasing the point data associated with the second user by the predetermined value in response to the input of the evaluation data.

8. A method for providing answers to a question, which is performed on the Internet, comprising the steps of:
providing a question input by a first user on a given web page;
receiving an answer for the question from a second user;
providing the answer on the web page in association with the question;
if a plurality of answers are input, receiving votes for the answers from a third user for a predetermined voting period; and
increasing polling score corresponding to the answers in response to the input of the votes.

9. The method as claimed in claim 8, further comprising the step of providing the polling score on the web page in association with the answers.

10. The method as claimed in claim 8, wherein the voting period is a predetermined period input by the first user and/or a period until the number of voters input by the first user is reached.

11. The method as claimed in claim 8, wherein the voting period is a predetermined period input by an operator and/or a period until a given number of voters input by the operator is reached.

12. The method as claimed in claim 8, wherein the step of receiving the answer comprises the step of receiving answers to the question from the second user for a predetermined answer period, and
the step of receiving the votes comprises the step of receiving the votes for the answers from the third user if the answer period has elapsed.

13. The method as claimed in claim 12, wherein the answer period is a predetermined period input by the first user.

14. The method as claimed in claim 8, further comprising the step of adopting one or more answers based on the polling score if the voting period has elapsed.

15. The method as claimed in claim 8, further comprising the step of, if the polling score corresponding to the answers is less than predetermined polling score after the voting period has elapsed, not adopting an answer and displaying that there is no adopted answer.

16. The method as claimed in claim 14, further comprising the step of displaying the adopted answer according to a predetermined display method.

17. The method as claimed in claim 14, further comprising the steps of:
deciding the second user who input the adopted answer as an answer adopter; and
increasing point data associated with the answer adopter by a predetermined value.

18. The method as claimed in claim 17, wherein the step of increasing the point data associated with the answer adopter by the predetermined value comprises the steps of:
maintaining point data associated with a user in a point database;
receiving compensation point data from the first user;
increasing the point data associated with the answer adopter by the compensation point data based on the compensation point data; and
reducing the point data associated with the first user by the compensation point data.

19. The method as claimed in claim 18, wherein the step of increasing the point data associated with the answer adopter by the compensation point data based on the compensation point data comprises the steps of:
if plural answers are adopted, distributing the compensation point data input by the first user in the ratio of the polling score corresponding to each of the adopted answers; and
increasing the point data associated with each answer adopter by the distributed compensation point data.

20. The method as claimed in claim 8, further comprising the step of increasing the point data associated with the third user by a predetermined value in response to the input of the votes.

21. The method as claimed in claim 20, wherein the step of increasing point data by a predetermined value comprises the steps of:
receiving a limit number corresponding to a predetermined unit period from an operator;
counting an input number that the third user inputs votes for the unit period; and
if the input number is below the limit number, increasing the point data associated with the third user by the predetermined value in response to the input of the votes.

22. The method as claimed in claim 8, wherein the step of receiving the votes comprises the steps of:
receiving a vote return command for the answers from the first user; and
receiving votes for the answers from the third user after the vote return command is input.

23. A method for providing answers for a question, which is performed on the Internet, comprising the steps of:
providing a question input by a first user on a given web page;
receiving answers to the question from a second user for a predetermined period;
providing the answers on the web page in association with the question;
if the period has elapsed, receiving input for adopting the answer and evaluation data for the adopted answer from the first user; and
increasing point data associated with the second user who input the adopted answer based on the evaluation data.

24. The method as claimed in claim 23, wherein the step of receiving the evaluation data comprises the step of receiving one of the given number of evaluation grades for the adopted answer from the first user, and
the step of increasing the point data comprises the steps of:
maintaining a point data value corresponding to the evaluation grade; and
increasing the point data associated with the second user by the point data value corresponding to the evaluation grade.

25. The method as claimed in claim 14 or 23, further comprising the steps of:
receiving a problem raised for the adopted answer by a fourth user;
providing the raised problem to the second user who input the adopted answer;
receiving an additional answer for the raised problem from the second user who input the adopted answer; and
providing the additional answer on the web page in association with the adopted answer.

26. The method as claimed in claim 25, wherein the step of receiving the additional answer comprises the steps of:
counting the number of additional answers input; and
allowing the additional answers not to be input if the number exceeds a given number.

27. The method as claimed in claim 14 or 23, further receiving a problem raised for the adopted answer by a fourth user;
providing the raised problem to the second user who input the adopted answer;
if the second user who input the adopted answer does not agree with the raised problem, receiving a cause of a rejection for the raised problem from the second user; and
providing the cause of the rejection to the fourth user.

28. The method as claimed in claim 27, further comprising the step of providing the raised problem in association with the adopted answer.

29. A method for providing answers to a question, which is performed on the Internet, comprising the steps of:
(a) providing a question input by a first user on a given web page;
(b) receiving answers for the question from a second user for a predetermined period;
(c) providing the answers on a web page in association with the question;
(d) deciding the question and an answer associated with the question as knowledge data;
(e) receiving a recommendation for the knowledge data from a third user; and
(f) providing the recommendation on the web page in association with the knowledge data.

30. The method as claimed in claim 29, further comprising the step of displaying the recommended knowledge data according to a predetermined display method.

31. The method as claimed in claim 29, wherein:
step (e) comprises the step of receiving a category associated with the knowledge data from the third user, and
step (f) comprises the step of displaying the category in association with the knowledge data.

32. The method as claimed in claim 29, further comprising the steps of:
maintaining the knowledge data and recommendation information associated with the knowledge data in a knowledge database;
receiving a search request for the knowledge data from a fourth user;
searching the knowledge database for the knowledge data in response to the search request;
determining an arranging order of the searched knowledge data; and
displaying the searched knowledge data according to the arranging order,
the step of determining the arranging order of the searched knowledge data comprises the steps of:
determining whether the searched knowledge data are recommended knowledge data based on the recommendation information; and
determining the arranging order by assigning a predetermined weight to the recommended knowledge data.

33. A computer-readable recording medium in which a program for implementing a method according to claim 1 is recorded.
